(19) United States
(12) Patent Application Publication
(10) Pub. No.: US 2025/0357499 A1
(43) Pub. Date: Nov. 20, 2025

(54) METHOD OF MANUFACTURING MEMBRANE-ELECTRODE ASSEMBLY WITH SHORTENED INITIAL ACTIVATION TIME AND MEMBRANE-ELECTRODE ASSEMBLY

(71) Applicants: Hyundai Motor Company, Seoul (KR); Kia Corporation, Seoul (KR)

(72) Inventors: Jee Youn Hwang, Hwaseong (KR); So Hwa Kim, Hwaseong (KR); Songi Oh, Hwaseong (KR); Hyoun Myung Park, Hwaseong (KR); Sung Hee Shin, Hwaseong (KR); Ah Hyeon Park, Hwaseong (KR); Won Jae Choi, Hwaseong (KR); Da Hee Kwak, Hwaseong (KR)

(21) Appl. No.: 18/825,469

(22) Filed: Sep. 5, 2024

(30) Foreign Application Priority Data
May 20, 2024 (KR) 10-2024-0064905

(51) Int. Cl. H01M 4/88; H01M 8/0221

(52) U.S. Cl. CPC H01M 4/8896; H01M 4/8882; H01M 8/0221

(57) ABSTRACT

Provided is a method for manufacturing a membrane-electrode assembly (MEA) with a shortened initial activation time that involves preparing an assembly with cathode and anode layers on opposite sides of an electrolyte membrane, and applying specific pressure and temperature conditions. The electrolyte membrane includes a hydrocarbon-based ionomer with an ion pair comprising a cation and an activator anion. The cathode and anode layers each contain a fluorine-based ionomer with a functional group derived from the activator. This process results in a unit cell that achieves 95% of its maximum current density in about 10 hours or less under specified conditions. The MEA itself features the hydrocarbon-based ionomer and the fluorine-based ionomer, with an activator or phosphoric acid present throughout, achieving the same rapid activation time.

### CROSS-REFERENCE TO RELATED APPLICATION

This application claims, under 35 U.S.C. § 119 (a), the benefit of Korean Patent Application No. 10-2024-0064905, filed on May 20, 2024, the entire contents of which are incorporated herein by reference.

### BACKGROUND

### Technical Field

The present disclosure relates to the field of fuel cell technology, specifically to methods for manufacturing membrane-electrode assemblies (MEAs) with reduced initial activation times. It involves the use of hydrocarbon-based and fluorine-based ionomers to enhance the performance and efficiency of fuel cells by decreasing the time required to reach optimal operational current density. This disclosure is particularly relevant to improving the start-up characteristics and overall performance of fuel cells used in various applications, including portable power systems, automotive applications, and stationary power generation.

### Background

In high-temperature polymer electrolyte membrane (PEM) fuel cells, activation may be performed by phosphoric acid or the like that is incorporated in an electrolyte membrane initially after manufacture. Optimal performance of the fuel cell may be realized only when phosphoric acid in the electrolyte membrane is sufficiently diffused to a catalyst layer (electrode layer) and electrical activity in the catalyst layer is ensured.

However, when simply bonding electrode layers to an electrolyte membrane, electrochemical activation may take a considerably long time, for example, 30 hours or more, which may reduce production efficiency and increase production cost. Accordingly, a method capable of shortening the initial activation time is required.

### SUMMARY OF THE DISCLOSURE

Therefore, the present disclosure has been made keeping in mind the problems encountered in the related art, and an object of the present disclosure is to provide a method of greatly reducing the activation time during initial operation in a polymer electrolyte membrane fuel cell and a membrane-electrode assembly applied thereto.

Another object of the present disclosure is to provide a membrane-electrode assembly with a low initial activation time after manufacture.

The objects of the present disclosure are not limited to the foregoing. The objects of the present disclosure will be able to be clearly understood through the following description and to be realized by the means described in the claims and combinations thereof.

In some embodiments, a method of manufacturing a membrane-electrode assembly (MEA) with a shortened initial activation time is provided. This method includes preparing an assembly with a cathode layer and an anode layer disposed on respective sides of an electrolyte membrane, and applying a predetermined pressure and temperature to the assembly to produce the membrane-electrode assembly. The electrolyte membrane comprises a hydrocarbon-based first ionomer, which is an ion pair comprising a cation group and an activator anion group from an activator. The cathode and anode layers each comprise a fluorine-based second ionomer containing a functional group derived from the activator. A unit cell comprising the membrane-electrode assembly has an activation time of about 10 hours or less during initial operation, where the activation time is the time to reach about 95% of a maximum current density under specified conditions of temperature, pressure, and gas flow rates.

The electrolyte membrane may comprise the activator at a concentration of about 4 mg/cm² or more. The cation group may include a quaternary ammonium ion functional group (—NH₃₊). The activator may be phosphoric acid (H3PO4), with the activator anion group being a phosphate ion (H2PO4−). The first ionomer may be configured such that at least one end in a repeat unit comprises a functional group R1 represented by Formula 1 below:

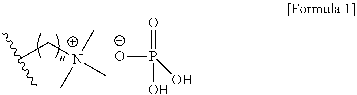

wherein n is an integer selected from 1 to 10. The first ionomer may include compounds such as phenyl group-containing polyphenylene-based compounds comprising R1, polycarbazole-based compounds comprising R1, polynorbornene-based compounds comprising R1, or combinations thereof. The first ionomer may also include compounds represented by Formulas 2 to 4 below:

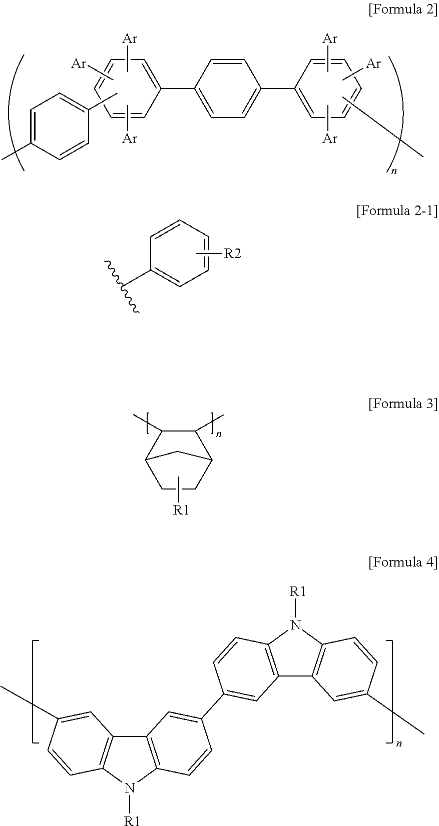

wherein n in Formula 2 is an integer from 100 to 10,000, Ar is a phenyl group represented by Formula 2-1, and at least one phenyl group comprises R1 represented by Formula 1, wherein R2 in Formula 2-1 is selected from any one of hydrogen, C1-C3 alkyl, and R1 represented by Formula 1, wherein n in Formula 3 is an integer from 200 to 10,000, and R1 is as represented in Formula 1, and wherein n in Formula 4 is an integer from 100 to 10,000, and R1 is as represented in Formula 1.

The first ionomer may also comprise a compound represented by Formula 2A below:

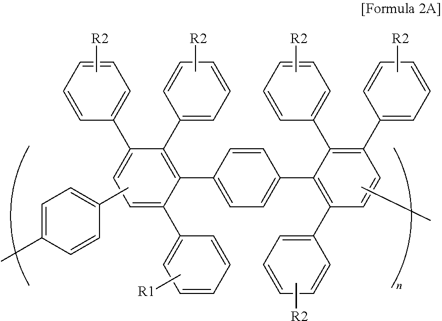

wherein n in Formula 2A is an integer from 100 to 10,000, R1 is as represented in Formula 1, and R² is independently selected from any one of hydrogen, C1-C3 alkyl, and R1.

The method may involve manufacturing the cathode and anode layers by applying a catalyst composition onto the electrolyte membrane or transferring an electrode layer formed from the catalyst composition. The catalyst composition may include a first solvent selected from N-methyl-2-pyrrolidone (NMP), dimethylformamide (DMF), dimethylacetamide (DMAc), dimethyl sulfoxide (DMSO), tetrahydrofuran (THF), chloroform, or combinations thereof, and a second solvent comprising a C1-C10 alcohol-based compound. The cathode and anode layers may have an average pore size of about 300 nm or more, an apparent density of about 0.26 g/ml or less, and a porosity of about 60 vol % or more. They may further include a perfluorosulfonic acid-based third ionomer. The second ionomer may comprise a poly(pentafluorostyrene)-based compound and include about 30 mol % to about 80 mol % of a repeating unit containing a functional group derived from the activator, with a weight average molecular weight of about 20 kDa to about 700 kDa. The predetermined pressure and temperature may be about 700 psi or more and about 120° C. or more.

In some embodiments, a membrane-electrode assembly with a shortened initial activation time is provided. This assembly includes an electrolyte membrane, a cathode layer, and an anode layer disposed on opposite sides of the electrolyte membrane, with an activator present throughout the assembly. The electrolyte membrane comprises a hydrocarbon-based first ionomer, which is an ion pair comprising a cation group and an activator anion group from an activator. The cathode and anode layers each comprise a fluorine-based second ionomer containing a functional group derived from the activator. A unit cell comprising the membrane-electrode assembly has an activation time of about 10 hours or less during initial operation, under specified conditions.

The cation group in the assembly may include a quaternary ammonium ion functional group (—NH3+). The activator may be phosphoric acid (H3PO4), with the activator anion group being a phosphate ion (H2PO4−). The cathode and anode layers may each have an average pore size of about 300 nm or more, an apparent density of about 0.26 g/ml or less, and a porosity of about 60 vol % or more. The electrolyte membrane may comprise the activator at a concentration of about 3.8 mg/cm² or more, the cathode layer may comprise the activator at a concentration of about 3.5 mg/cm² or more, and the anode layer may comprise the activator at a concentration of about 2.2 mg/cm² or more.

In some embodiments, a membrane-electrode assembly with a shortened initial activation time is provided, comprising an electrolyte membrane and a cathode layer and an anode layer provided on respective sides of the electrolyte membrane, with phosphoric acid present throughout the assembly. The electrolyte membrane comprises a hydrocarbon-based first ionomer, which is an ion pair comprising a quaternary ammonium cation group (—NH3+) and a phosphate anion (H2PO4−). The cathode and anode layers each comprise a fluorine-based second ionomer containing a functional group comprising phosphoric acid. The electrolyte membrane may include the activator at a concentration of about 3.8 mg/cm² or more, the cathode layer may include the activator at a concentration of about 3.5 mg/cm² or more, and the anode layer may include the activator at a concentration of about 2.2 mg/cm² or more.

As discussed, the method and system suitably include use of a controller or processer.

### BRIEF DESCRIPTION OF THE DRAWINGS

FIG. 1 schematically shows stacking an electrolyte membrane including phosphoric acid, a cathode layer, and an anode layer, which requires a long activation time.

FIG. 2 schematically shows a process of manufacturing a membrane-electrode assembly with a shortened initial activation time according to an aspect of the present disclosure.

FIG. 3 shows a scanning electron microscope image of the surface of the electrode layer (cathode layer) manufactured in each of Reference Example 1 and Example 1.

FIG. 4 is a graph showing electrochemical characteristics of a unit cell including the membrane-electrode assembly manufactured in each of Reference Example 1 and Example 1.

FIG. 5 is a graph showing the current density depending on the activation time of a unit cell including the membrane-electrode assembly manufactured in each of

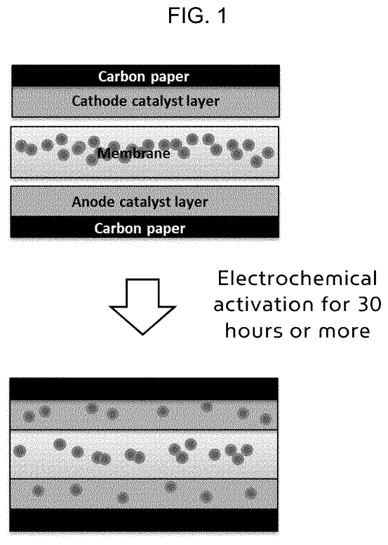

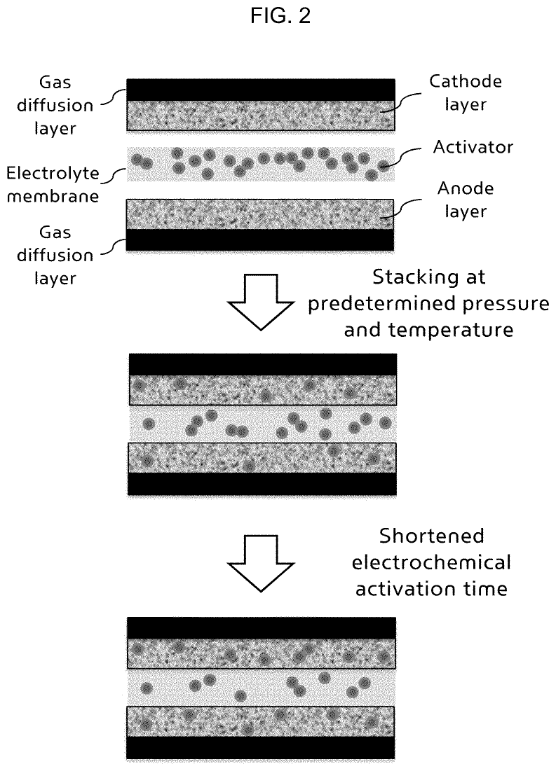

### Comparative Example 1 and Example 2.

FIG. 6 is a graph showing the current density depending on the activation time of a unit cell including the membrane-electrode assembly manufactured in Comparative Example 2.

FIG. 7 is a flowchart schematically showing a process of manufacturing a membrane-electrode assembly with a shortened initial activation time according to an aspect of the present disclosure.

### DETAILED DESCRIPTION

The above and other features of the present disclosure will now be described in detail referring to certain exemplary embodiments thereof illustrated in the accompanying drawings, which are given hereinbelow by way of illustration only, and thus are not limitative of the present disclosure.

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases.

As used herein, “about” when used in connection with a numeric value, is intended to include values that are close to, but not exactly, the number to the nearest significant figure. For example, a numerical value of “about 5” may include values ranging from 4.6 to 5.4. Alternatively, the term “about” with respect to a numerical value means plus or minus 10% of the numerical value, unless indicated otherwise.

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

Method of Manufacturing Membrane-Electrode Assembly with Shortened Initial Activation Time

A method of manufacturing a membrane-electrode assembly with a shortened initial activation time according to an aspect of the present disclosure may include:
(a) preparing an assembly with a cathode layer and an anode layer formed on respective sides of an electrolyte membrane, and
(b) manufacturing a membrane-electrode assembly by applying a predetermined pressure and temperature to the assembly.

The electrolyte membrane in step (a) may include a hydrocarbon-based first ionomer, and the first ionomer may be configured such that an ion pair including a cation group and an activator anion is introduced.

The electrolyte membrane in step (a) may include the activator at a concentration of 4 mg/cm² or more.

The cathode layer and the anode layer formed in step (a) may include a fluorine-based second ionomer containing a functional group derived from the activator.

A unit cell including the membrane-electrode assembly may have an activation time of 10 hours or less during initial operation.

The activation time is the time to reach about 95% of a maximum current density during activation treatment under conditions of a unit cell effective area of about 25 cm², a temperature of about 160° C., an atmospheric pressure of about 1.5 bar, an air flow rate of about 2500 sccm, and a hydrogen flow rate of about 500 sccm.

The activation time may be about 5 hours or less, or about 4 hours or less, and about 2 hours or more.

The effective area may correspond to an area where the anode layer and the cathode layer are in contact with the electrolyte membrane. Here, the anode layer and the cathode layer may have the same area.

In the first ionomer, the activator may have a concentration of about 4 mg/cm² to about 6.5 mg/cm². If the concentration of the activator is less than about 4 mg/cm², the initial activation time may be tens of hours or more, whereas if the concentration of the activator is greater than about 6.5 mg/cm², the catalyst in the electrode layers may be poisoned or proton conductivity may decrease due to excessive activator.

In the first ionomer, the cation group may include a cation group that has predetermined ion-pair interaction energy with the activator ion, and an example thereof may include a quaternary ammonium ion functional group (—NH3+).

In the first ionomer, the activator ion may include, for example, a phosphate ion (H₂PO₄₋), and the activator ion may include a phosphoric acid-based material, phosphoric acid. The phosphoric acid-based material may include phosphoric acid, phosphorous acid, pyrophosphoric acid, triphosphoric acid, hypophosphorous acid, etc.

The ion-pair interaction energy between the cation group and the activator ion may be about 100 kcal/mol to about 300 kcal/mol. This ion-pair interaction energy makes it possible to prevent excessive leakage of phosphate ions from the electrolyte membrane during pressurization and heating in the subsequent step, and may contribute to shortening the activation time as desired.

The first ionomer may be a polymer that is polymerized with a single repeat unit, and the repeat unit may include therein a C4-C8 substituted or unsubstituted arylene, substituted or unsubstituted norbornylene, substituted or unsubstituted fluorenylene, carbazolylene, etc.

The first ionomer may be configured such that at least one terminal in a repeat unit, for example, a hydrogen terminal, is substituted with a functional group R1 represented by Formula 1 below.

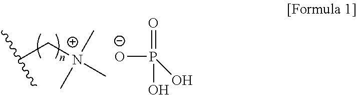

In Formula 1, n is an integer from 1 to 10.

The functional group R1 according to Formula 1 may include a C1-C10 cationic alkylammonium group and a phosphate anion joined thereto by ion-pair interaction.

The first ionomer may include a compound selected from the group consisting of a phenyl group-containing polyphenylene-based compound including R1, a polycarbazole-based compound including R1, a polynorbornene-based compound including R1, and combinations thereof.

The first ionomer may include a compound selected from the group consisting of compounds represented by Formulas 2 to 4 below and combinations thereof.

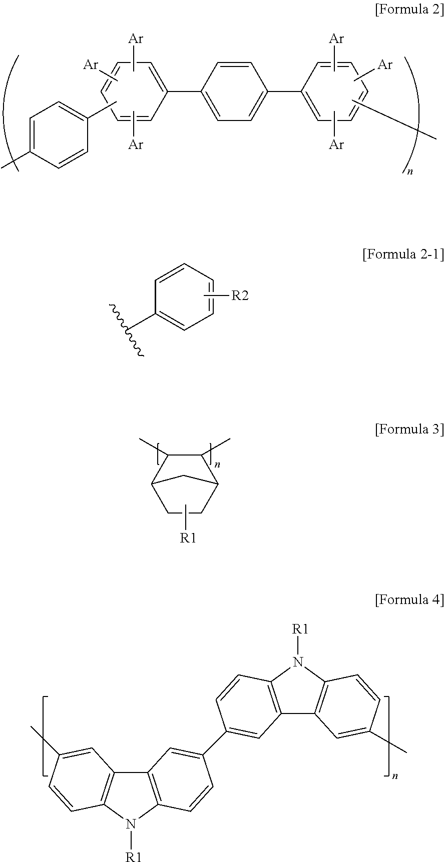

(in Formula 2, n is an integer from 100 to 10,000, Ar is a phenyl group represented by Formula 2-1, and at least one of phenyl groups includes R1 represented by Formula 1,
in Formula 2-1, R2 is any one selected from among hydrogen, C1-C3 alkyl, and R1 represented by Formula 1,
in Formula 3, n is an integer from 200 to 10,000, and R1 is as represented in Formula 1, and
in Formula 4, n is an integer from 100 to 10,000, and R1 is as represented in Formula 1.)

In Formula 2, n may be 1,000 or less, in Formula 3, n may be 2,000 or less, and in Formula 4, n may be 1,000 or less.

Since the first ionomer includes such a cyclic structure in the main chain, expansion of the area (cm²) may be maintained at 5 vol % or less but greater than 0 vol % even when the activator is added at a predetermined concentration, deformation of the electrolyte membrane during stacking may be minimized, and the initial activation time may be stably shortened.

The first ionomer may include a compound represented by Formula 2A below.

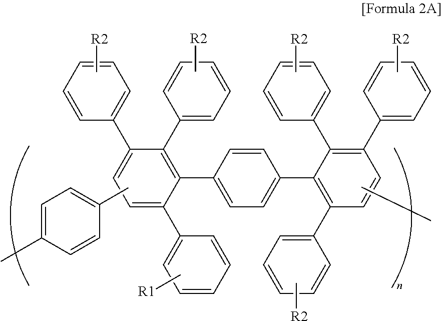

(in Formula 2A, n is an integer from 100 to 10,000, R1 is as represented in Formula 1, and R2 is independently any one selected from among hydrogen, C1-C3 alkyl, and R1.)

The cathode layer and the anode layer in step (a) may be manufactured by applying a catalyst composition including different solvents onto both sides of the electrolyte membrane, or by transferring an electrode layer formed by applying the catalyst composition onto a release paper, a gas diffusion layer, etc. to both sides, i.e., a top side and a bottom side of the electrolyte membrane. The solvents may include a first solvent and a second solvent that are different.

The first solvent may include any one selected from the group consisting of N-methyl-2-pyrrolidone (NMP), dimethylformamide (DMF), dimethylacetamide (DMAc), dimethyl sulfoxide (DMSO), tetrahydrofuran (THF), chloroform, and combinations thereof, and the second solvent may include a C1-C10 alcohol-based compound. The second solvent may be included in an amount of about 10 wt % to about 30 wt % based on the total amount of the catalyst composition.

By applying these solvents in forming the cathode layer and the anode layer in step (a), specific ranges of electrode layer pore size, apparent density, and porosity may be achieved, and the initial activation time may be shortened.

The cathode layer and the anode layer formed in step (a) may have an average pore size of about 300 nm to about 600 nm, an apparent density of about 0.12 g/ml to about 0.26 g/ml, and a porosity of about 60 vol % to about 80 vol %. By the electrode layers having such a pore size and apparent density, the activator may be more easily diffused in the initial activation process and the activation time may be shortened.

The cathode layer and the anode layer in step (a) may further include a perfluorosulfonic acid-based third ionomer. Examples of the perfluorosulfonic acid-based third ionomer may include Nafion, Flemion, Aciplex, Aquivion, 3M PFSA, Dow, etc. The amount, by weight, of the third ionomer in the cathode layer and the anode layer may be about 30 wt % to about 50 wt % based on the total amount of ionomers (second ionomer+third ionomer). When the amount of the third ionomer falls in the above range, a decrease in proton conductivity may be minimized.

In forming the cathode layer and the anode layer in step (a), the catalyst metal contained in the catalyst composition, cathode layer, and anode layer may include any one selected from the group consisting of platinum, ruthenium, palladium, gold, silver, iridium, rhodium, osmium, and combinations thereof. An example thereof may include platinum-ruthenium. The catalyst metal may be supported on a support, and the support may be carbon.

The amount of the catalyst metal in the cathode layer and the anode layer formed in step (a) may be about 0.1 mg/cm² to about 3 mg/cm².

In the cathode layer and the anode layer in step (a), the second ionomer may include a poly(pentafluorostyrene)-based compound, and the amount of a repeat unit containing a functional group derived from the activator based on the total amount of repeat units may be about 30 mol % to about 80 mol %. The weight average molecular weight (Mw) of the second ionomer may be from about 20 kDa to about 700 kDa (20,000 g/mol to 700,000 g/mol). The functional group derived from the activator may be a functional group including at least a portion of the main component of the activator, and when the activator is a phosphoric acid-based material, the functional group may be a phosphorous acid functional group (—H₂PO₃) or a phosphonic acid functional group.

An example of the second ionomer may include a compound represented by Formula 5 below.

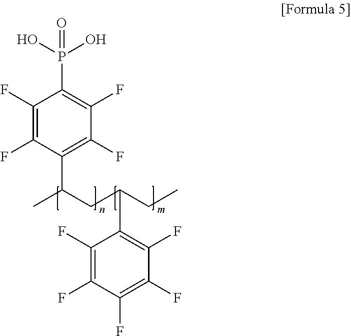

(in Formula 5, n/(n+m) is 0.3 to 0.8 based on n+m=100 mol %.)

In step (b), the pressure may be from about 700 psi to about 1,000 psi and the temperature may be from about 120° C. to about 160° C. Step (b) may be performed for about 50 to about 100 seconds. If the pressure is less than 700 psi, the initial activation time may be long, whereas if the pressure is greater than 1,000 psi, the electrolyte membrane may be damaged and a large amount of fuel gas such as hydrogen may permeate. If the temperature is less than 120° C., the activator may not sufficiently diffuse into the electrode layer, whereas if the temperature exceeds 160° C., durability of the membrane-electrode assembly and fuel cell may decrease. The temperature may correspond to the temperature of the interface between the electrolyte membrane and the electrode layer.

By the above method, a membrane-electrode assembly with a shortened initial activation time may be easily manufactured.

Membrane-Electrode Assembly with Shortened Initial Activation Time

A membrane-electrode assembly with a shortened initial activation time according to another aspect of the present disclosure may include an electrolyte membrane and a cathode layer and an anode layer provided on respective sides of the electrolyte membrane, in which an activator is contained throughout the membrane-electrode assembly.

The electrolyte membrane may include a hydrocarbon-based first ionomer, and the first ionomer may be configured such that an ion pair including a cation group and an activator anion is introduced.

The electrolyte membrane may include the activator at a concentration of about 3.8 mg/cm² or more.

The cathode layer and the anode layer may include a fluorine-based second ionomer containing a functional group derived from the activator.

A unit cell including the membrane-electrode assembly may have an activation time of 10 hours or less during initial operation.

The activation time is the time to reach about 95% of the maximum current density during activation treatment under conditions of a unit cell effective area of about 25 cm², a temperature of about 160° C., an atmospheric pressure of about 1.5 bar, an air flow rate of about 2500 sccm, and a hydrogen flow rate of about 500 sccm.

The electrolyte membrane of the membrane-electrode assembly, the first ionomer included therein, the cathode layer and anode layer, the second ionomer, third ionomer, and catalyst metal included therein, and the activator are as described above, so a redundant description thereof will be omitted.

The electrolyte membrane may include the activator at a concentration of about 3.8 mg/cm² to about 6.5 mg/cm².

The cathode layer may include the activator at a concentration of about 3.5 mg/cm² to about 6.3 mg/cm².

The anode layer may include the activator at a concentration of about 2.2 mg/cm² to about 6 mg/cm².

The concentration of the activator may be a concentration before initial activation treatment.

Since the membrane-electrode assembly has such activator concentrations in the electrolyte membrane and the electrode layers, the initial activation time may be more easily shortened.

A fuel cell including the membrane-electrode assembly may operate at a relatively high temperature and may stably operate at a temperature from about 80 to about 160° C. or from about 120 to about 160° C.

A better understanding of the present disclosure may be obtained through the following examples and comparative examples. However, these examples are not to be construed as limiting the technical spirit of the present disclosure.

### Example 1

### a1) Manufacture of Electrode Layers

A ionomer mixture was prepared by mixing a poly(pentafluorostyrene)-based second ionomer (PWN70, Mw=136 kDa) including 70 mol % of a poly(2,3,5,6-tetrafluorostyrene-4-phosphonic acid) repeat unit based on the total amount of repeat units and a perfluorosulfonic acid-based third ionomer (Nafion) at a weight ratio of 6:4.

A catalyst composition was prepared by adding the mixed ionomer to a mixed solvent including n-propanol and N-methyl-2-pyrrolidone at a weight ratio of 1:1 so that the mixed ionomer/carbon weight ratio was 0.4 and further adding a platinum catalyst (PtM).

A cathode layer/gas diffusion layer and an anode layer/gas diffusion layer were manufactured by applying the catalyst composition onto a carbon paper gas diffusion layer followed by drying.

a2) Doping of Electrolyte Membrane with Activator

Phenylated polyphenylene (QAPOH, Mw=450 kDa) represented by Formula 2B below was prepared as an electrolyte membrane, and was doped with phosphoric acid at about 23° C. for 3 days so that the concentration of phosphoric acid was 6 mg/cm².

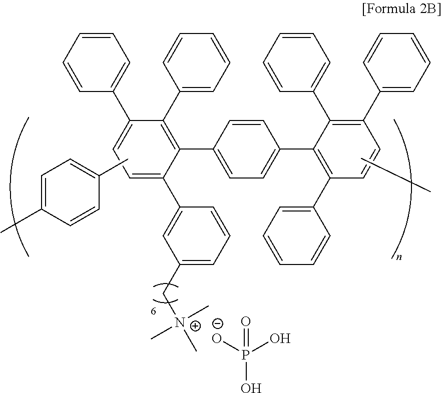

(in Formula 2B, n is a value that satisfies the weight average molecular weight.)

### b) Manufacture of Membrane-Electrode Assembly

A membrane-electrode assembly was manufactured by bonding the cathode layer and the anode layer to respective sides of the electrolyte membrane and stacking the resulting assembly under conditions of a temperature of about 140° C., a pressure of about 700 psi, and a time of about 60 seconds.

The concentration of phosphoric acid (mg/cm²) after stacking treatment was as follows.
Cathode: 4.791
Electrolyte membrane: 5.060
Anode: 2.926

### Example 2

A membrane-electrode assembly was manufactured under the same conditions as in Example 1, with the exception that the concentration of phosphoric acid in the electrolyte membrane in step a2) was changed to 4.3 mg/cm².

### Reference Example 1

A membrane-electrode assembly was manufactured under the same conditions as in Example 1, with the exception that, when manufacturing the electrode layers in step a1), N-methyl-2-pyrrolidone was used alone as the solvent.

### Comparative Example 1

A membrane-electrode assembly was manufactured under the same conditions as in Example 1, with the exception that the concentration of phosphoric acid in the electrolyte membrane in step a2) was changed to 3.5 mg/cm².

### Comparative Example 2

A membrane-electrode assembly was manufactured under the same conditions as in Example 2, with the exception that, in the stacking in step b), simple bonding was conducted without applying separate temperature and pressure.

The main details of Examples, Reference Example, and Comparative Examples are shown in Table 1 below.

TABLE 1

| | | (a2) Concentration | | |
|---|---|---|---|---|
| | (a1) Solvent in | of phosphoric | | |
| | manufacturing | acid in | | |
| | electrode | electrolyte | | (b) Stacking |
| Classification | layers | membrane | | conditions |
| Example 1 | NMP + n-propanol | 6 | mg/cm² | 140° C., 800 |
| | | | | psi, 60 s |
| Example 2 | NMP + n-propanol | 4.3 | mg/cm² | 140° C., 800 |
| | | | | psi, 60 s |
| Reference | NMP | 6 | mg/cm² | 140° C., 800 |
| Example 1 | | | | psi, 60 s |
| Comparative | NMP + n-propanol | 3.5 | mg/cm² | 140° C., 800 |
| Example 1 | | | | psi, 60 s |
| Comparative | NMP + n-propanol | 4.3 | mg/cm² | None |
| Example 2 | | | | |

### Test Example 1—Analysis of Characteristics Depending on Solvent in Manufacturing Electrode Layers

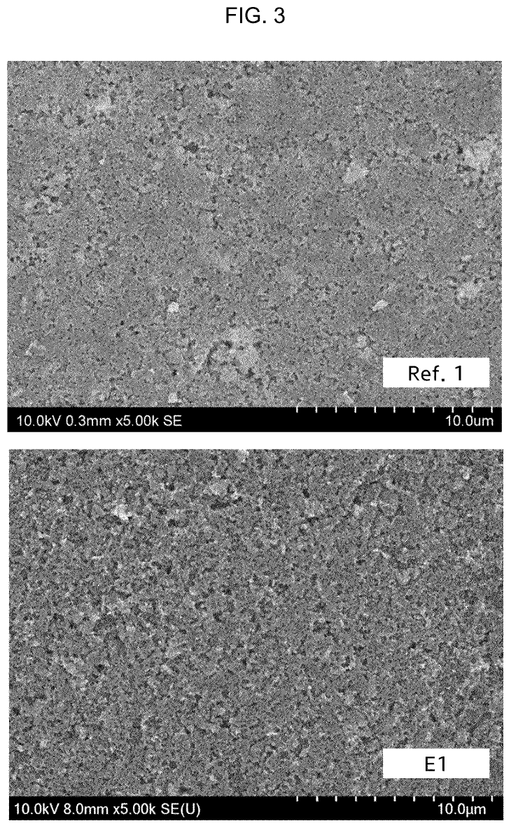

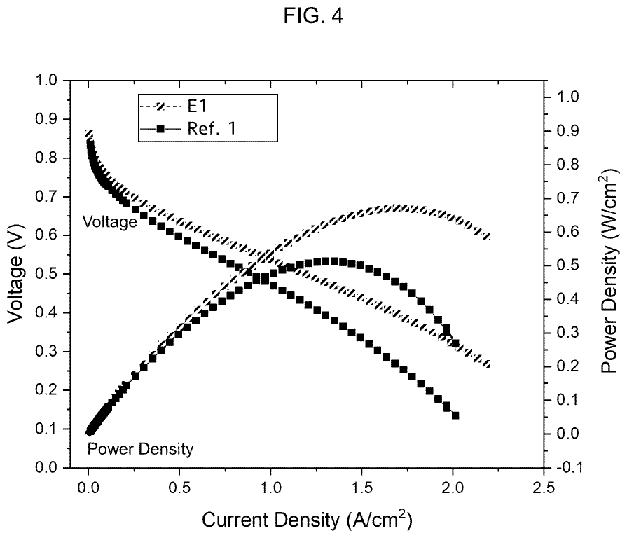

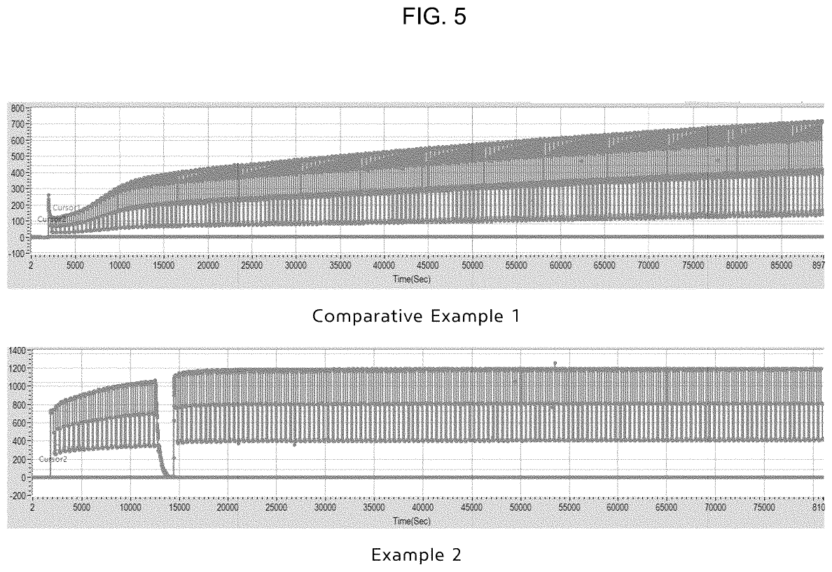

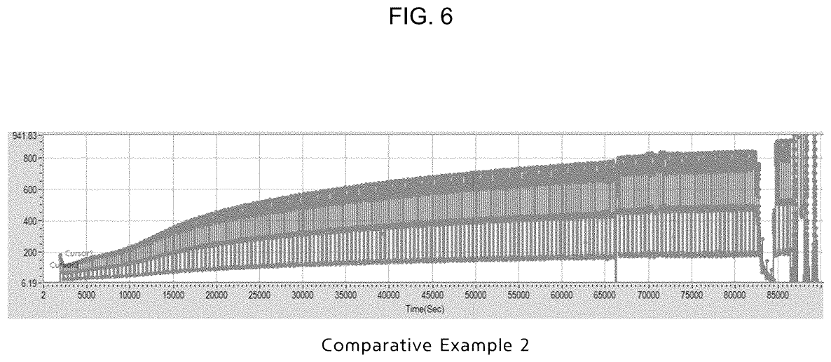

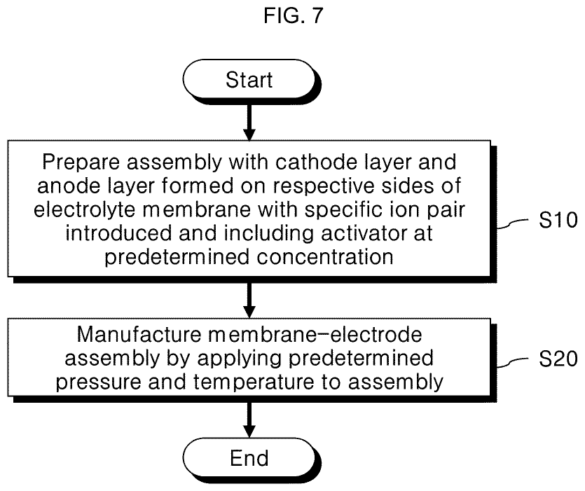

A unit cell composed of the membrane-electrode assembly manufactured in each of Example 1 and Reference Example 1 was subjected to activation treatment under conditions of a temperature of 160° C. for 4 hours, an atmospheric pressure of 1.5 bar, an air flow rate of 2500 sccm, and a hydrogen flow rate of 500 sccm. And, the I-V polarization curve and power density of each unit cell were measured using a fuel cell test station, and the results thereof are shown in FIG. 4 and Table 2 below. Also, the surface of the electrode layer (cathode layer) of each unit cell was observed using a scanning electron microscope, and pore size and density were measured using a mercury porosimeter, and the results thereof are shown in FIG. 3 and Table 2 below.

TABLE 2

| | Average pore | Apparent | HFC | Maximum power |
|---|---|---|---|---|
| | size | density | (mΩ · | density |
| Classification | (nm) | (g/ml) | cm²) | (W/cm²) |
| Reference | 194 | 0.28 | 123.4 | 0.51 |
| Example 1 | | | | |
| Example 1 | 445 | 0.22 | 88.8 | 0.67 |

Referring thereto, Example 1 (E1), in which the electrode layers were formed by applying the mixed solvent, exhibited a larger average pore size, lower apparent density, and similar porosity of about 68 vol % compared to Reference Example 1 (Ref. 1).

Moreover, Example 1 showed low membrane resistance (HFR) and high maximum power density after the same activation treatment compared to Reference Example 1, and activation progressed less in Reference Example 1.

As is apparent from the above description, according to the present disclosure, the activation time during initial operation of a polymer electrolyte membrane fuel cell and a membrane-electrode assembly applied thereto can be greatly reduced, thereby lowering production cost and increasing productivity.

The effects of the present disclosure are not limited to the foregoing. It should be understood that the effects of the present disclosure include all effects that can be inferred from the description of the present disclosure.

Although specific embodiments of the present disclosure have been described, those skilled in the art will appreciate that the present disclosure may be embodied in other specific forms without changing the technical spirit or essential features thereof. Thus, the embodiments described above should be understood to be non-limiting and illustrative in every way.

What is claimed is:

1. A method of manufacturing a membrane-electrode assembly with a shortened initial activation time, comprising:
(a) preparing an assembly with a cathode layer and an anode layer disposed on respective sides of an electrolyte membrane; and
(b) applying a predetermined pressure and temperature to the assembly to produce the membrane-electrode assembly,
wherein the electrolyte membrane comprises a hydrocarbon-based first ionomer, wherein the first ionomer comprises an ion pair comprising a cation group and an activator anion group from an activator,
wherein the cathode layer and the anode layer each comprise a fluorine-based second ionomer containing a functional group derived from the activator,
wherein a unit cell comprising the membrane-electrode assembly has an activation time of about 10 hours or less during initial operation, and
wherein the activation time is a time to reach about 95% of a maximum current density during activation treatment under conditions of a unit cell effective area of about 25 cm², a temperature of about 160° C., an atmospheric pressure of about 1.5 bar, an air flow rate of about 2500 sccm, and a hydrogen flow rate of about 500 sccm.

2. The method of claim 1, wherein the electrolyte membrane comprises the activator at a concentration of about 4 mg/cm² or more.

3. The method of claim 1, wherein the cation group comprises a quaternary ammonium ion functional group (—NH₃⁺).

4. The method of claim 1, wherein the activator comprises phosphoric acid (H₃PO₄), and the activator anion group comprises a phosphate ion (H₂PO₄₋).

5. The method of claim 1, wherein the first ionomer is configured such that at least one end in a repeat unit of the first ionomer comprises a functional group R1 represented by Formula 1 below: 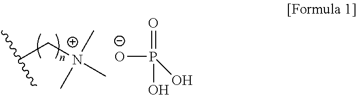
wherein n is an integer selected from 1 to 10.

6. The method of claim 5, wherein the first ionomer comprises a compound selected from the group consisting of a phenyl group-containing polyphenylene-based compound comprising R1, a polycarbazole-based compound comprising R1, a polynorbornene-based compound comprising R1, and combinations thereof.

7. The method of claim 6, wherein the first ionomer comprises a compound selected from the group consisting of compounds represented by Formulas 2 to 4 below, and combinations thereof, 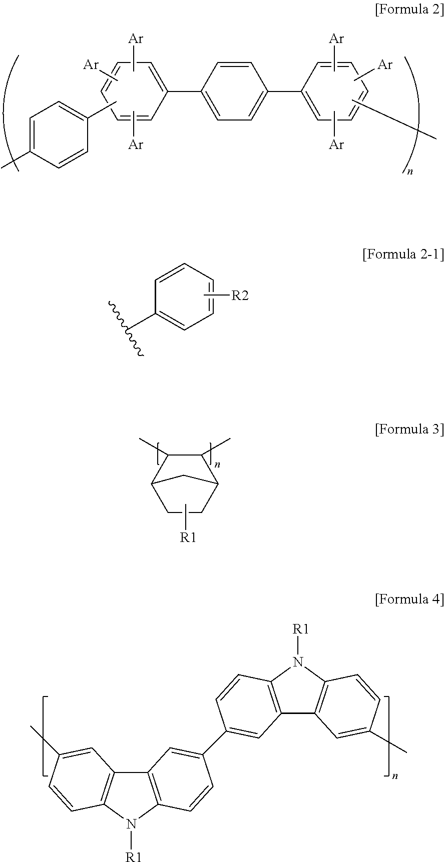
wherein n in Formula 2 is an integer from 100 to 10,000, Ar is a phenyl group represented by Formula 2-1, and at least one phenyl groups comprises R1 represented by Formula 1,
wherein R2 in Formula 2-1 is selected from any one of hydrogen, C1-C3 alkyl, and R1 represented by Formula 1,
wherein n in Formula 3 is an integer from 200 to 10,000, and R1 is as represented in Formula 1, and
wherein n in Formula 4 is an integer from 100 to 10,000, and R1 is as represented in Formula 1.

8. The method of claim 7, wherein the first ionomer comprises a compound represented by Formula 2A below, 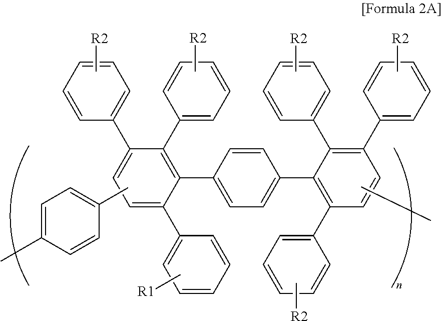
wherein n in Formula 2A is an integer from 100 to 10,000, R1 is as represented in Formula 1, and R2 is independently selected from any one of hydrogen, C1-C3 alkyl, and R1.

9. The method of claim 1, wherein:
the cathode layer and the anode layer are manufactured by;
(1) applying a catalyst composition comprising a first solvent and a second solvent different from the first solvent onto top and bottom sides of the electrolyte membrane, or
(2) transferring an electrode layer formed from the catalyst composition to the top and the bottom sides of the electrolyte membrane,
wherein the first solvent comprises any one selected from the group consisting of N-methyl-2-pyrrolidone (NMP), dimethylformamide (DMF), dimethylacetamide (DMAc), dimethyl sulfoxide (DMSO), tetrahydrofuran (THF), chloroform, and combinations thereof, and
wherein the second solvent comprises a C1-C10 alcohol-based compound.

10. The method of claim 1, wherein the cathode layer and the anode layer each comprise an average pore size of about 300 nm or more, an apparent density of about 0.26 g/ml or less, and a porosity of about 60 vol % or more.

11. The method of claim 1, wherein the cathode layer and the anode layer further comprise a perfluorosulfonic acid-based third ionomer.

12. The method of claim 1, wherein the second ionomer comprises a poly(pentafluorostyrene)-based compound, and the second ionomer comprises about 30 mol % to about 80 mol % of a repeating unit containing a functional group derived from the activator, based on a total amount of repeating units, and wherein a weight average molecular weight of the second ionomer is from about 20 kDa to about 700 kDa.

13. The method of claim 1, wherein the predetermined pressure and the temperature are about 700 psi or more and about 120° C. or more.

14. A membrane-electrode assembly with a shortened initial activation time, comprising an electrolyte membrane; and a cathode layer and an anode layer disposed on opposite sides of the electrolyte membrane, wherein an activator is present throughout the membrane-electrode assembly,
wherein the electrolyte membrane comprises a hydrocarbon-based first ionomer, and the first ionomer comprises an ion pair comprising a cation group and an activator anion group from an activator,
wherein the cathode layer and the anode layer each comprise a fluorine-based second ionomer containing a functional group derived from the activator,
wherein a unit cell comprising the membrane-electrode assembly has an activation time of about 10 hours or less during initial operation, and
wherein the activation time is a time to reach about 95% of a maximum current density during activation treatment under conditions of a unit cell effective area of about 25 cm², a temperature of about 160° C., an atmospheric pressure of about 1.5 bar, an air flow rate of about 2500 sccm, and a hydrogen flow rate of about 500 sccm.

15. The membrane-electrode assembly of claim 14, wherein the cation group comprises a quaternary ammonium ion functional group (—NH₃+).

16. The membrane-electrode assembly of claim 14, wherein the activator comprises phosphoric acid (H₃PO₄), and the activator anion ion group comprises a phosphate ion (H₂PO₄₋).

17. The membrane-electrode assembly of claim 14, wherein the cathode layer and the anode layer each comprise an average pore size of about 300 nm or more, an apparent density of about 0.26 g/ml or less, and a porosity of about 60 vol % or more.

18. The membrane-electrode assembly of claim 14, wherein:
the electrolyte membrane comprises the activator at a concentration of about 3.8 mg/cm² or more,
the cathode layer comprises the activator at a concentration of about 3.5 mg/cm² or more, and
the anode layer comprises the activator at a concentration of about 2.2 mg/cm² or more.

19. A membrane-electrode assembly with a shortened initial activation time, comprising an electrolyte membrane; and a cathode layer and an anode layer provided on respective sides of the electrolyte membrane, wherein phosphoric acid is present throughout the membrane-electrode assembly,
wherein the electrolyte membrane comprises a hydrocarbon-based first ionomer, wherein the first ionomer comprises an ion pair comprising a quaternary ammonium cation group (—NH₃₊) and a phosphate anion (H₂PO₄₋), and
the cathode layer and the anode layer each comprise a fluorine-based second ionomer containing a functional group comprising the phosphoric acid.

20. The membrane-electrode assembly of claim 19, wherein:
the electrolyte membrane comprises the activator at a concentration of about 3.8 mg/cm² or more,
the cathode layer comprises the activator at a concentration of about 3.5 mg/cm² or more, and
the anode layer comprises the activator at a concentration of about 2.2 mg/cm² or more.
